(19) United States
(12) Patent Application Publication
(10) Pub. No.: US 2021/0129586 A1
(43) Pub. Date: May 6, 2021

(54) Wheel Traction Surface for Vehicle

(71) Applicant: Ahmed Shahzad, West Chicago, IL (US)

(72) Inventor: Ahmed Shahzad, West Chicago, IL (US)

(21) Appl. No.: 16/675,193

(22) Filed: Nov. 5, 2019

(51) Int. Cl. B60B 39/12; E01B 29/40

(52) U.S. Cl. CPC B60B 39/12; E01B 29/40

(57) ABSTRACT

A wheel traction surface in the event of a vehicle experiencing a lack of traction during an emergency, while experiencing conditions such as snow, rain, ice, or being stuck in a ditch. The wheel traction surface includes a support surface, wherein the support surface is flat and configured to support a vehicle. The wheel traction surface includes a plurality of securing members configured to grip or drive into a ground surface, wherein the securing members are positioned on a first side of the support surface. The wheel traction surface includes a plurality of studs configured to grip on or more tires of the vehicle, on a second side of the support surface.

### FIELD OF THE INVENTION

The present invention relates generally to devices and methods directed toward assisting vehicles in gaining traction while in a ditch or on ground with a lack of traction. In particular, this disclosure relates to a wheel traction surface of the type that may be inserted between a wheel and the surface or a ditch to provide additional traction, to assist a vehicle with mobility.

### BACKGROUND

Numerous and varied wheel traction assistance structures have been suggested heretofore, but have suffered from anyone or more of a number of shortcomings among which may be mentioned unduly high cost so as to be unattractive economically, permanent deformability under wheel weight, dangerous cutting edges or sharp points that may injure the users hands or other objects during handling or in storage, bulkiness or unwieldiness for storage purposes, difficult to clean, relative ineffectiveness under unusual circumstances such as deep snow, mud or sand, and a vehicle experiencing a lack of traction due to being stuck in a ditch.

This presents special driving hazards and causes numerous accidents which take their toll in human life and property.

In order to safeguard against these hazards, drivers have been using for many years various forms of chains which were mounted on individual tires to increase traction. Also special snow tires have been designed with particular gripping treads in order to gain added traction. However, these devices proved to be inefficient, expensive, cumbersome and inconvenient and worst of all detrimental and damaging to the road surface.

A major disadvantage lies in another known device (U.S. Pat. No. 3,858,803) providing for transverse openings in a traction mat. When the road is covered with a layer of snow or ice, the latter could fill in the openings in the mat and form a solid slippery surface which would render the mat ineffective in providing any added traction to the stranded vehicle.

It is accordingly an important object of the present invention to overcome the foregoing and other disadvantages, defects, deficiencies, inefficiencies, shortcomings and problems inherent in prior structures and to attain important improvements and advantages in a new and improved vehicle traction mat as will hereinafter become apparent.

### SUMMARY OF THE INVENTION

The present invention provides for a traction device that would substantially eliminate the above disadvantages and would resolve the long standing problems arising from lack of sufficient traction to motor vehicles in hazardous weather conditions. In accordance to the previously discussed problems, this disclosure provides for the solution of a wheel traction surface configured to provide traction to vehicle in order to effectively gain mobility while on an unstable surface.

A wheel traction surface in the event of a vehicle experiencing a lack of traction during an emergency, while experiencing conditions such as snow, rain, ice, or being stuck in a ditch. The wheel traction surface includes a support surface, wherein the support surface is flat and configured to support a vehicle.

The wheel traction surface includes a plurality of securing members configured to grip or drive into a ground surface, wherein the securing members are positioned on a first side of the support surface. The wheel traction surface includes a plurality of studs configured to grip on or more tires of the vehicle, on a second side of the support surface.

Additional objects, features and advantages of the device of the invention will become apparent from the following detailed discussion and the accompanying drawings.

### BRIEF DESCRIPTION OF THE FIGURES

In the accompanying drawings there is illustrated in detail a preferred embodiment of the invention, this being indicative, however, of one of various ways in which the principle of the invention may be employed.

Other objects, features and advantages of the invention will be readily apparent from the following description of certain preferred embodiments thereof, taken in conjunction with the accompanying drawing although variations and modifications may be effected without departing from the spirit and scope of the novel concepts embodied in the disclosure, and in which:

FIG. 1 depicts a perspective view of the wheel traction surface, in accordance with an example;

FIG. 2 depicts a top perspective view of the wheel traction surface, in accordance with an example;

FIG. 3 depicts a side perspective of the wheel traction surface, in accordance with an example;

FIG. 4a depicts a perspective view of the wheel traction surface interacting with a tire of a vehicle in a forward direction, in accordance with an example; and

FIG. 4b depicts a perspective view of the wheel traction surface interacting with a tire of a vehicle in a reverse direction, in accordance with an example.

### DETAILED DESCRIPTION

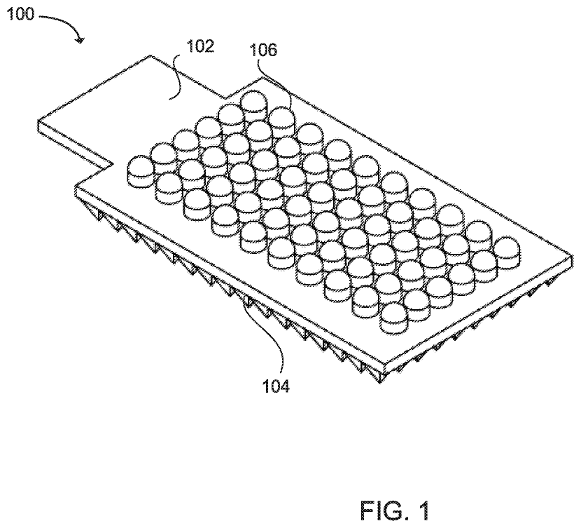

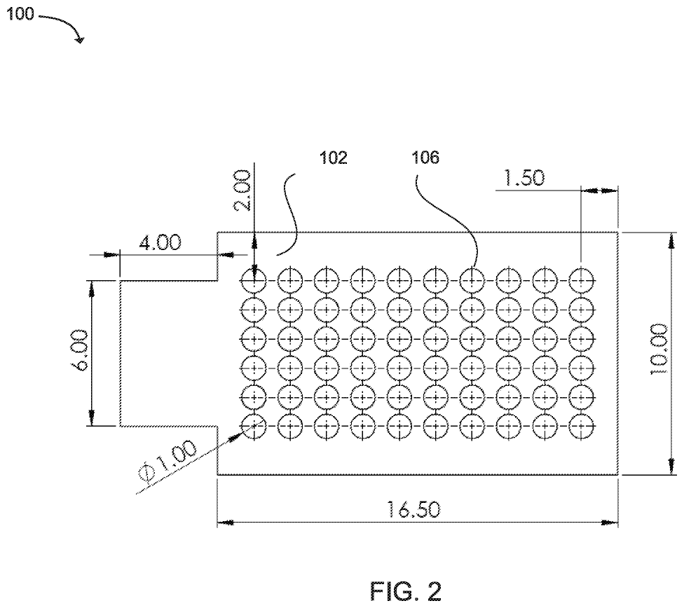

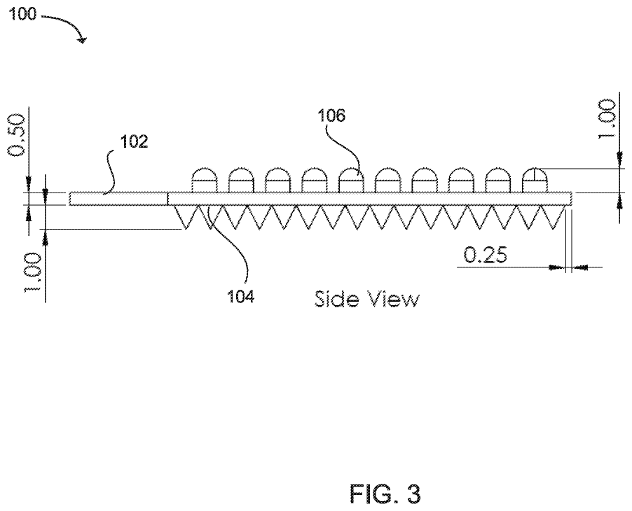

FIG. 1-3 shows a wheel traction surface 100. The wheel traction surface 100 has a support surface 102 that is in a preferred embodiment flat and configured to support a vehicle, with a thickness of at least a half an inch. In an alternative embodiment, the support surface 102 can be manufactured to with a width thicker than an inch. The wheel traction surface can also include a plurality of securing members 104 configured to grip or drive into a ground surface. The securing members 104 can be metal, plastic, or another solid material that is configured to grip a ground surface, and in some instances dig into the ground surface to prevent sliding. The securing members 104 can additionally be positioned on a first side of the support surface 102. The wheel traction surface 100 can further comprise of a plurality of studs 106 are configured to grip on or more tires of the vehicle. Additionally, the plurality of studs 106 are positioned on a second side of the support surface, opposite of the securing members 104.

In one embodiment, the support surface 102 comprises of a flat and elongated body. This is clearly depicted in each of FIG. 1-3, where the support surface can be configured to any length that would be suitable to support vehicles of all sizes.

In some embodiments, the support surface 102 is formed from materials selected from the group of rubber, elastic material, plastic, wood, poly-blend, metal, Plexiglas, or carbon fiber.

In one embodiment, the plurality of securing members 104 are configured to extend from the support surface, into the ground surface. The securing members 104 being configured to extend into the ground, can be operable to secure themselves into the ground at various lengths. The securing members 104 can be configured to extend at least 1 inch into a ground surface, allowing the securing members 104 to stay in place while a vehicle is in motion, or the securing members 104 are under the weight of the vehicle.

In one embodiment, the plurality of studs 106 can be positioned in a single cluster through the support surface 102.

In one embodiment, the plurality of studs 106 are positioned in a plurality of clusters through the support surface 102.

In one embodiment, the support surface 102 can comprise of a length of at least 16.5 inches.

In one embodiment, the support surface 102 can comprise of a width of at least 6 inches.

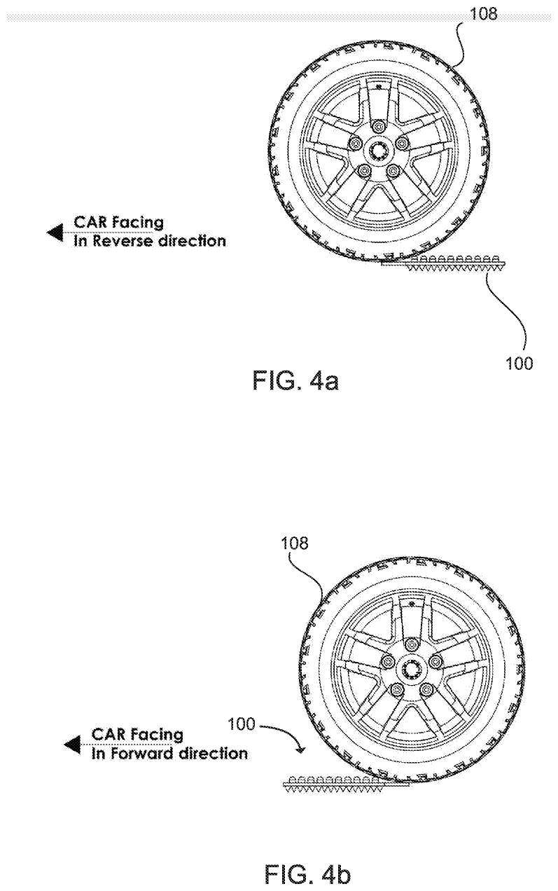

FIGS. 4a and 4b illustrates a perspective view of the wheel traction surface 100 interacting with a tire 108 of a vehicle. As depicted in FIG. 4, the plurality of studs 106 are configured to make contact with the one or more tires of a vehicle, resulting in increased traction at multiple points of contact of the tires. In one embodiment, the plurality of studs 106 are configured to make contact with the one or more tires 108 of a vehicle in a forward direction or in a reverse direction.

In one embodiment, the support surface 102 can be one single surface or multiple surfaces positioned underneath each tire 108 of the vehicle.

In one embodiment, the support surface 102 can be positioned underneath at least two tires 108 of the vehicle.

It is noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner.

This invention has other applications, potentially, and one skilled in the art could discover these. The explication of the features of this invention does not limit the claims of this application; other applications developed by those skilled in the art will be included in this invention.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A wheel traction surface for a vehicle comprising:
a support surface, wherein the support surface is flat and configured to support a vehicle;
a plurality of securing members configured to grip or drive into a ground surface, wherein the securing members are positioned on a first side of the support surface; and
a plurality of studs configured to grip on or more tires of the vehicle, on a second side of the support surface.

2. The wheel traction surface of claim 1, wherein the support surface comprises of a flat and elongated body.

3. The wheel traction surface of claim 1, wherein the support surface is formed from materials selected from the group of rubber, elastic material, plastic, wood, poly-blend, metal, Plexiglas, or carbon fiber.

4. The wheel traction surface of claim 1, wherein the plurality of securing members are configured to extend from the support surface, into the ground surface.

5. The wheel traction surface of claim 1, wherein the plurality of studs are configured to make contact with the one or more tires of a vehicle, resulting in increased traction at multiple points of contact of the tires.

6. The wheel traction surface of claim 5, wherein the plurality of studs are configured to make contact with the one or more tires of a vehicle in a forward direction or in a reverse direction.

7. The wheel traction surface of claim 5, wherein the plurality of studs are positioned in a single cluster through the support surface.

8. The wheel traction surface of claim 5, wherein the plurality of studs are positioned in a plurality of clusters through the support surface.

9. The wheel traction surface of claim 1, wherein the support surface can comprise of a length of at least 16.5 inches.

10. The wheel traction surface of claim 1, wherein the support surface can comprise of a width of at least 6 inches.

11. The wheel traction surface of claim 1, wherein the support surface can be one single surface or multiple surfaces positioned underneath each tire of the vehicle.

12. The wheel traction surface of claim 1, wherein the support surface can be positioned underneath at least two tires of the vehicle.
